(19) United States
(12) Patent Application Publication
(10) Pub. No.: US 2025/0147717 A1
(43) Pub. Date: May 8, 2025

(54) AUDIO PROCESSING METHOD AND APPARATUS, ELECTRONIC DEVICE, AND STORAGE MEDIUM

(71) Applicant: Beijing Zitiao Network Technology Co., Ltd., Haidian District (CN)

(72) Inventors: Ye Ma, Beijing (CN); Chang Xiao, Beijing (CN)

(21) Appl. No.: 18/934,568

(22) Filed: Nov. 1, 2024

(30) Foreign Application Priority Data
Nov. 3, 2023 (CN) 202311458978.8

(51) Int. Cl. G06F 3/16

(52) U.S. Cl. CPC G06F 3/165

(57) ABSTRACT

The present disclosure relates to the field of computer technologies, and discloses an audio processing method and apparatus, an electronic device, and a storage medium. The method includes: obtaining media data to be processed and audio metadata of the media data to be processed; performing first loudness compensation on the media data to be processed based on the audio metadata to obtain first media data, where the first loudness compensation includes loudness compensation for dynamic range control; determining a second loudness compensation value corresponding to peak limiting based on an audio feature of the first media data; and performing second loudness compensation and peak limiting on the first media data based on the second loudness compensation value to determine target media data for playback.

### CROSS-REFERENCE TO RELATED APPLICATION

This application claims priority to Chinese Application No. 202311458978.8 filed on Nov. 3, 2023, the disclosure of which is incorporated herein by reference in its entirety.

### FIELD

The present disclosure relates to the field of computer technologies, and in particular, to an audio processing method and apparatus, an electronic device, and a storage medium.

### BACKGROUND

A terminal needs to process audio before playing media data to ensure loudness equalization.

### SUMMARY

In view of this, the present disclosure provides an audio processing method and apparatus, an electronic device, and a storage medium.

According to a first aspect, the present disclosure provides an audio processing method. The method includes:
obtaining media data to be processed and audio metadata of the media data to be processed;
performing first loudness compensation on the media data to be processed based on the audio metadata to obtain first media data, where the first loudness compensation includes loudness compensation for dynamic range control;
determining a second loudness compensation value corresponding to peak limiting based on an audio feature of the first media data; and
performing second loudness compensation and peak limiting on the first media data based on the second loudness compensation value to determine target media data for playback.

According to a second aspect, the present disclosure provides an audio processing apparatus. The apparatus includes:
an obtaining module configured to obtain media data to be processed and audio metadata of the media data to be processed;
a first loudness processing module configured to perform first loudness compensation on the media data to be processed based on the audio metadata to obtain first media data, where the first loudness compensation includes loudness compensation for dynamic range control;
a second loudness compensation value determining module configured to determine a second loudness compensation value corresponding to peak limiting based on an audio feature of the first media data; and
a second loudness processing module configured to perform second loudness compensation and peak limiting on the first media data based on the second loudness compensation value to determine target media data for playback.

According to a third aspect, the present disclosure provides an electronic device, including: a memory and a processor, where the memory and the processor are communicatively connected to each other, the memory stores computer instructions, and the processor executes the computer instructions to perform the audio processing method according to the first aspect or any implementation corresponding to the first aspect.

According to a fourth aspect, the present disclosure provides a computer-readable storage medium having stored thereon computer instructions that are used to cause a computer to perform the audio processing method according to the first aspect or any implementation corresponding to the first aspect.

### BRIEF DESCRIPTION OF THE DRAWINGS

To more clearly describe the technical solutions in specific implementations of the present disclosure or in the prior art, the accompanying drawings for describing the specific implementations or the prior art will be briefly described below. Apparently, the accompanying drawings in the description below show some implementations of the present disclosure, and those of ordinary skill in the art may still derive other accompanying drawings from these accompanying drawings without creative efforts.

FIG. 1 is a schematic flowchart of an audio processing method according to an embodiment of the present disclosure;

FIG. 2 is a schematic flowchart of another audio processing method according to an embodiment of the present disclosure;

FIG. 3 is a schematic flowchart of still another audio processing method according to an embodiment of the present disclosure;

FIG. 4 is a block diagram of a data flow for audio processing according to an embodiment of the present disclosure;

FIG. 5 is a block diagram of a data flow for audio processing according to an embodiment of the present disclosure;

FIG. 6 is a block diagram of a structure of an audio processing apparatus according to an embodiment of the present disclosure; and

FIG. 7 is a schematic diagram of a hardware structure of an electronic device according to an embodiment of the present disclosure.

### DETAILED DESCRIPTION OF EMBODIMENTS

To make the objectives, technical solutions and advantages of embodiments of the present disclosure clearer, the technical solutions in the embodiments of the present disclosure will be described clearly and completely below with reference to the accompanying drawings in the embodiments of the present disclosure. Apparently, the embodiments described are some rather than all of the embodiments of the present disclosure. All other embodiments obtained by those of ordinary skill in the art based on the embodiments of the present disclosure without any creative efforts shall fall within the scope of protection of the present disclosure.

It can be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, in response to reception of an active request from the user, prompt information is sent to the user to clearly inform the user that a requested operation will require access to and use of the personal information of the user. As such, the user can independently choose, based on the prompt information, whether to provide the personal information to software or hardware, such as an electronic device, an application, a server, or a storage medium, that performs operations in the technical solutions of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may further include a selection control for the user to choose whether to “agree” or “disagree” to provide the personal information to the electronic device.

It can be understood that the above process of notifying and obtaining the authorization of the user is only illustrative and does not constitute a limitation on the implementations of the present disclosure, and other manners that satisfy the relevant laws and regulations may also be applied in the implementations of the present disclosure.

In the related art, in order to achieve loudness equalization at a playback terminal, different videos with different loudnesses are pulled to the same posting loudness or playback loudness by multiplying a volume gain, followed by processing of a dynamic range control curve, and peak limiting. However, in the above solution, the loudness is affected to some extent after processing of a dynamic range control curve and peak limiting. Therefore, even after processing of the volume gain, it is difficult to achieve loudness equalization of media data for playback.

In the audio processing method provided in the embodiments of the present disclosure, peak limiting performed on media data has specific impact on a loudness, and dynamic range control also affects the loudness. Therefore, loudness compensation is performed for both dynamic range control and peak limiting. The second loudness compensation value for peak limiting is determined based on the audio feature of the first media data, and is related to the first media data obtained after dynamic range control. This can ensure accuracy of the obtained second loudness compensation value. In the method, loudness compensation exists in dynamic range control and peak limiting, so that a loudness error of target media data can be controlled to be within a specific range, thereby improving a loudness equalization effect.

Further, when a loudness compensation value is determined, a corresponding loudness compensation value determining way is selected based on a target performance requirement, to balance a computing power of a playback terminal and a loudness equalization effect. To be specific, for a playback terminal having a low computing power, a determining way having low processing complexity may be selected to obtain the loudness compensation value; and for a playback terminal having a high computing power, a determining way having high processing complexity may be selected to obtain the loudness compensation value.

Further, because peak limiting is the last step of audio processing, in order to control an error range, for the loudness compensation value determining way for peak limiting, different determining ways are set for different error ranges.

Further, the method is further used to obtain a frequency response curve and/or a cutoff frequency of a playback device to determine a corresponding target loudness and/or loudness compensation based on actual performance data of the playback device. Therefore, the method can provide a particular device with an optimal loudness equalization effect adapted to a playback frequency response of the device.

It should be noted that the audio processing method provided in the present disclosure may be applied to a short video playback scenario, a local media data playback scenario, or the like. There is no limitation on specific application scenarios, which are set based on actual requirements.

According to an embodiment of the present disclosure, an audio processing method embodiment is provided. It should be noted that steps shown in a flowchart of the accompanying drawings may be performed, for example, in a computer system including a group of computer-executable instructions. Although a logical sequence is shown in the flowchart, the steps shown or described may be performed in a sequence different from that shown herein in some cases.

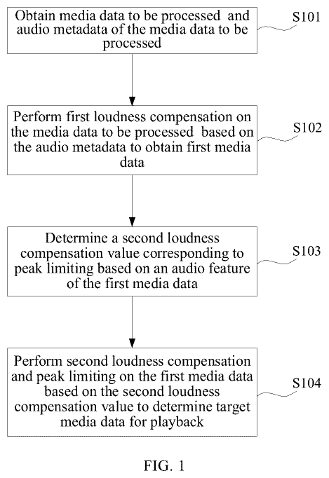

This embodiment provides an audio processing method that may be used for an electronic device, such as a server or a playback terminal. FIG. 1 is a flowchart of an audio processing method according to an embodiment of the present disclosure. As shown in FIG. 1, the process includes the following steps.

Step S101: Obtain media data to be processed and audio metadata of the media data to be processed.

An obtaining way for the media data to be processed is related to an application scenario of the audio processing method. If the method is applied to a short video playback scenario, the media data to be processed comes from a server corresponding to a short video playback application; or if the method is applied to a local media data playback scenario, the media data to be processed comes from locally cached media data. There is no limitation on the obtaining way for the media data to be processed herein, which is set based on actual requirements.

The audio metadata of the media data to be processed includes, but is not limited to, a source loudness, a maximum short-term loudness, an energy peak, a loudness range, a speech proportion, starting and ending points of the loudness range, device loudness compensation, and the like of the media data to be processed. The audio metadata is obtained by analyzing an audio feature of the media data to be processed. There is no limitation on the analysis method herein. If the application scenario is a terminal video playback scenario, the audio metadata is sent to a playback terminal together with the media data to be processed; or if the application scenario is a local media data playback scenario, the audio metadata is obtained by analyzing local media data to be processed.

Step S102: Perform first loudness compensation on the media data to be processed based on the audio metadata to obtain first media data.

The first loudness compensation includes loudness compensation for dynamic range control.

A source loudness of media data to be played is included in the audio metadata to determine a target loudness based on other data in the audio metadata. A loudness gain is obtained from a difference between the target loudness and the source loudness, and then loudness compensation is performed on the media data to be processed by using the loudness gain. Therefore, the first loudness compensation includes loudness gain processing and loudness compensation for dynamic range control.

The loudness compensation for dynamic range control is determined based on the audio metadata and control parameters for dynamic range control, that is, a loudness compensation value is obtained by determining impact of dynamic range control on a loudness and based on the audio metadata.

On this basis, the media data to be processed is subjected to loudness gain processing, and then the control parameters for dynamic range control are used to perform loudness compensation for dynamic range control on the media data to be processed to obtain the first media data. Certainly, other processing may alternatively be performed before dynamic range control. There is no limitation on such processing herein.

Step S103: Determine a second loudness compensation value corresponding to peak limiting based on an audio feature of the first media data.

The audio feature of the first media data includes, but is not limited to, an audio peak of the first media data. Because peak limiting is used to limit the audio peak of the first media data, an impact of peak limiting on a loudness may be determined based on an audio peak before peak limiting and an audio peak after peak limiting to obtain the second loudness compensation value. Certainly, the second loudness compensation value may alternatively be determined by a pre-trained loudness compensation value model that includes the audio feature of the first media data as an input and includes the second loudness compensation value as an output. Because a loudness compensation value is used to compensate for impact of peak limiting on a loudness, the input of the loudness compensation value model further includes peak limiting parameters. Further, because the first media data is obtained after dynamic range control, the input of the loudness compensation value model further includes control parameters for dynamic range control, and the like. Input parameters for the loudness compensation value model may be set based on actual requirements.

Step S104: Perform second loudness compensation and peak limiting on the first media data based on the second loudness compensation value to determine target media data for playback.

After the second loudness compensation value is obtained, peak limiting is performed on the first media data, and then the second loudness compensation value is used to perform loudness compensation on the media data obtained after the peak limiting to obtain the target media data for playback. Alternatively, the second loudness compensation value may be used to perform second loudness compensation on the first media data, and then peak limiting is performed on the first media data to obtain the target media data.

In the audio processing method provided in this embodiment, peak limiting performed on media data has specific impact on a loudness, and dynamic range control also affects the loudness. Therefore, loudness compensation is performed for both dynamic range control and peak limiting. The second loudness compensation value for peak limiting is determined based on the audio feature of the first media data, and is related to the first media data obtained after dynamic range control. This can ensure accuracy of the obtained second loudness compensation value. In the method, loudness compensation exists in dynamic range control and peak limiting, so that a loudness error of target media data can be controlled to be within a specific range, thereby improving a loudness equalization effect.

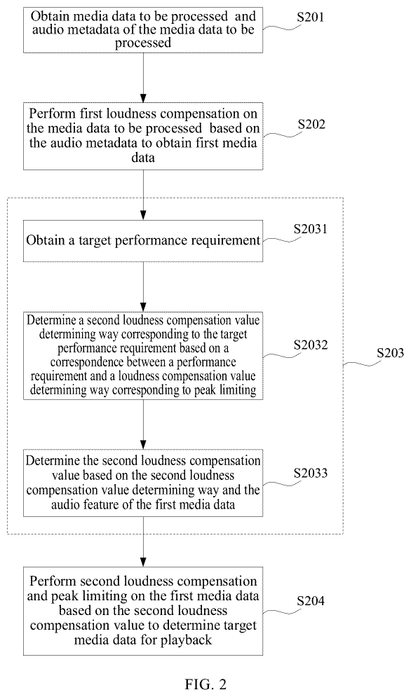

This embodiment provides an audio processing method that may be used for an electronic device, such as a server or a playback terminal. FIG. 2 is a flowchart of an audio processing method according to an embodiment of the present disclosure. As shown in FIG. 2, the process includes the following steps.

Step S201: Obtain media data to be processed and audio metadata of the media data to be processed. Refer to step S101 of the embodiment shown in FIG. 1 for details. Details are not described herein again.

Step S202: Perform first loudness compensation on the media data to be processed based on the audio metadata to obtain first media data.

The first loudness compensation includes loudness compensation for dynamic range control. Refer to step S102 of the embodiment shown in FIG. 1 for details. Details are not described herein again.

Step S203: Determine a second loudness compensation value corresponding to peak limiting based on an audio feature of the first media data.

Specifically, step S203 includes:

Step S2031: Obtain a target performance requirement.

The target performance requirement is used to characterize a requirement for an audio processing result, focusing on processing performance or on a loudness equalization effect. The target performance requirement may be determined by querying a computing power of a playback device. If the computing power is lower than a preset value, it indicates that processing performance of the playback device is insufficient, and audio processing may be performed from the perspective of saving performance overheads. If the computing power is higher than the preset value, it indicates that the processing performance of the playback device is good, and audio processing may be performed from the perspective of improving the loudness equalization effect.

The target performance requirement may alternatively be determined interactively, for example, an interactive control for performance requirements is displayed on an interface of the playback terminal. By interacting with the interactive control, a user correspondingly obtains an interactive operation result of the user, so as to determine the target performance requirement.

The target performance requirement may alternatively be characterized by an error range, for example, an input control for an error range is set on an interface of the playback terminal. By interacting with the input control, the user correspondingly obtains an error range value input by the user. The target performance requirement is determined based on the input error range value. If the error range exceeds a preset value, it indicates a current focus on processing performance; if the error range is lower than the preset value, it indicates a current focus on a loudness equalization effect.

In some optional implementations, the target performance requirement is determined based on a loudness processing mode of a current playback device or an error range of loudness compensation. The loudness processing mode includes at least two loudness processing submodes, for example, a loudness processing submode 1 indicates a focus on processing performance, and a loudness processing submode 2 indicates a focus on a loudness equalization effect. The loudness processing mode may be determined interactively. For example, the current playback device is provided with an interactive interface used for displaying at least two loudness processing submodes, and a target loudness processing submode is determined through interaction with the interactive interface, so as to obtain the target performance requirement.

The target performance requirement is determined based on the loudness processing mode or the error range of loudness compensation, that is, a plurality of ways are provided to determine the target performance requirement, which expands loudness equalization processing scenarios.

Step S2032: Determine a second loudness compensation value determining way corresponding to the target performance requirement based on a correspondence between a performance requirement and a loudness compensation value determining way corresponding to peak limiting.

Different performance requirements correspond to different loudness compensation value determining ways, and the loudness compensation values herein are used to compensate for impact of peak limiting on a loudness. For example, a performance requirement a corresponds to a loudness compensation value determining way a1, and a performance requirement b corresponds to a loudness compensation value determining way b1, and so on.

After the target performance requirement is obtained, a second loudness compensation value determining way corresponding to the target performance requirement is obtained by querying the above correspondence. The second loudness compensation value is a loudness compensation value corresponding to peak limiting.

In the above description, the target performance requirement may be obtained based on the loudness processing mode of the current playback device. If the selected loudness processing mode characterizes the target performance requirement as focusing on processing performance, the processing complexity of the second loudness compensation value determining way is low; or if the selected loudness processing mode characterizes the target performance requirement as focusing on a loudness equalization effect, the processing complexity of the second loudness compensation value determining way is high.

In some optional implementations, a loudness equalization effect in the performance requirement is positively correlated with processing complexity of the loudness compensation value determining way for peak limiting, and loudness equalization processing performance in the performance requirement is negatively correlated with the processing complexity of the loudness compensation value determining way for peak limiting.

Specifically, a higher processing complexity of the loudness compensation value determining way for peak limiting indicates a better loudness equalization effect; and vice versa. A lower processing complexity of the loudness compensation value determining way for peak limiting indicates a lower requirement for processing performance.

For example, if the computing power of the current playback terminal is limited, it is necessary to save processing overheads to satisfy high processing performance, and correspondingly, the processing complexity of the corresponding loudness compensation value determining way is low.

The loudness equalization effect in the performance requirement is positively correlated with the processing complexity, and the loudness equalization processing performance in the performance requirement is negatively correlated with the processing complexity, thereby satisfying a balance between the device processing performance and the equalization effect of the playback device.

In some optional implementations, the peak loudness compensation value determining way includes a determining way based on a mapping relationship between a peak loudness compensation value and an audio feature, and a determining way based on a peak loudness compensation model, and the peak loudness compensation model includes the audio feature as an input and includes the loudness compensation value as an output. Processing complexity of the determining way based on the mapping relationship between the peak loudness compensation value and the audio feature is less than that of the determining way based on the peak loudness compensation model.

The peak loudness compensation value determining way includes two ways. The processing complexity and the loudness equalization effect of the determining way based on the mapping relationship are less than those of the determining way based on the peak loudness compensation model. The mapping relationship is corresponding to the peak loudness compensation value and the audio feature. A fitted curve may be obtained by curve-fitting the peak loudness compensation value and the audio feature to characterize the mapping relationship between the peak loudness compensation value and the audio feature.

The peak loudness compensation model includes the audio feature as an input and includes the loudness compensation value as an output. An initial peak loudness compensation model is trained by using a sample dataset, and model parameters of the initial peak loudness compensation model are fixed after a plurality of rounds of iterations to obtain the peak loudness compensation model. The audio feature includes, but is not limited to, the audio peak of the first media data, a source loudness, and the like. The input to the peak loudness compensation model may further include control parameters for dynamic range control, such as a starting point of a dynamic range control curve and a compression ratio.

Requirements for processing complexity of different determining ways are satisfied by providing two different determining ways. Higher processing complexity correspondingly indicates a better loudness equalization effect; and lower processing complexity correspondingly indicates a lower loudness equalization performance requirement, so as to satisfy a higher performance requirement.

Step S2033: Determine the second loudness compensation value based on the second loudness compensation value determining way and the audio feature of the first media data.

After the second loudness compensation value determining way is obtained, the second loudness compensation value is obtained based on the audio feature of the first media data. If the determining way is determined based on the mapping relationship, the second loudness compensation value may be calculated by using the audio feature and the mapping relationship; or if the determining way is determined based on the peak loudness compensation model, the audio feature is input into the peak loudness compensation model to obtain the second loudness compensation value.

In some optional implementations, if the peak loudness compensation value determining way is the determining way based on the mapping relationship between the peak loudness compensation value and the audio feature, step S2033 includes:

Step a1: Obtain a target peak for the peak limiting and a current audio peak in the audio feature to obtain a difference between the current audio peak and the target peak.

Step a2: Determine the second loudness compensation value based on the difference and the mapping relationship.

The mapping relationship characterizes a relationship between a peak difference and a loudness compensation value, and the peak difference is a difference between the target peak for peak limiting and the current audio peak in the audio feature. The relationship between the peak difference and the loudness compensation value is characterized by an exponential curve, which is obtained by curve-fitting a large quantity of peak differences and loudness compensation values.

For example, the relationship between the second loudness compensation value and the peak is expressed by using the following equation:

Second loudness compensation value=(a−log_{b}(target peak−current audio peak))*c

where a, b, and c are constants greater than zero, a is greater than or equal to 1, b is greater than zero and less than 1, and c is greater than 1. For example, a=1, b=0.9, and c=6.

It should be noted that if the second loudness compensation value calculated by using the above equation is less than zero, the second loudness compensation value is adjusted to zero.

In the case of the determining way based on the mapping relationship, the second loudness compensation value is determined by using the difference between the target peak and the current audio peak. In this case, a data processing amount is small, and a requirement for processing performance is low to satisfy a requirement for high processing performance of a playback device with a limited computing power.

In some optional implementations, if the peak loudness compensation value determining way is the determining way based on the peak loudness compensation model, step S2033 includes:

Step b1: Determine a target submodel in the peak loudness compensation model based on a loudness equalization effect in the target performance requirement, where the peak loudness compensation model includes a plurality of submodels, and the submodels have different processing complexity.

Step b2: Determine the second loudness compensation value based on the target submodel and the audio feature of the first media data.

The peak loudness compensation model includes a plurality of submodels, and the submodels have different processing complexity to satisfy different loudness equalization effects. For example, if an error range of less than 5 is required in the loudness equalization effect, the peak loudness compensation model is determined to be used. Further, different submodels are used based on different error ranges. A smaller error range indicates a higher processing complexity of a submodel, and correspondingly, a better loudness equalization effect obtained.

In some implementations, the submodels include, but are not limited to, a decision tree model, a neural network model, and the like. Because processing complexity of the decision tree model is lower than that of the neural network model, the decision tree model may be used when the error range is 3 or 4; or the neural network model is used when the error range is 1 or 2.

Certainly, the above models are merely examples of some models and do not limit the protection scope of the present disclosure, which are set based on actual requirements.

A peak loudness compensation gain model is used to calculate the second loudness compensation value, and the second loudness compensation value is obtained by model inference, which can make full use of processing performance of a playback device to obtain a relatively accurate second loudness compensation value. In addition, the peak loudness compensation gain model includes a plurality of submodels, and the submodels have different processing complexity to satisfy playback devices having different computing powers.

Step S204: Perform second loudness compensation and peak limiting on the first media data based on the second loudness compensation value to determine target media data for playback. Refer to step S104 of the embodiment shown in FIG. 1 for details. Details are not described herein again.

In the audio processing method provided in this embodiment, different performance requirements correspond to different loudness compensation value determining ways for peak limiting, thereby satisfying different target performance requirements and achieving a personalized setting for loudness equalization.

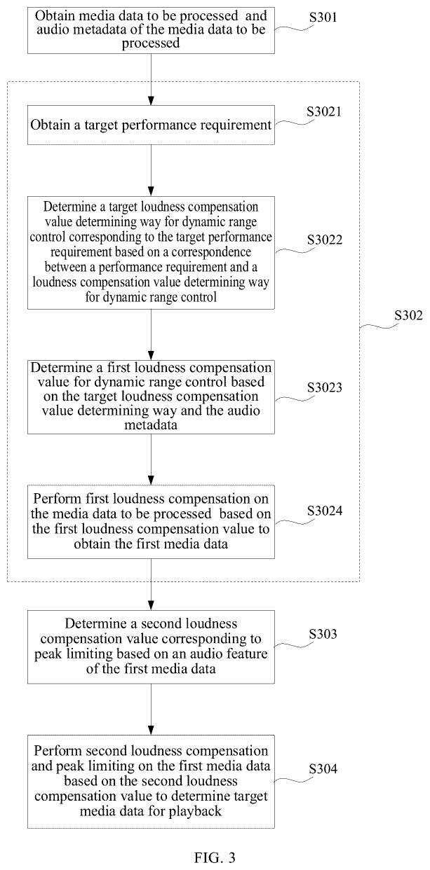

This embodiment provides an audio processing method that may be used for an electronic device, such as a server or a playback terminal. FIG. 3 is a flowchart of an audio processing method according to an embodiment of the present disclosure. As shown in FIG. 3, the process includes the following steps.

Step S301: Obtain media data to be processed and audio metadata of the media data to be processed. Refer to step S101 of the embodiment shown in FIG. 1 for details. Details are not described herein again.

Step S302: Perform first loudness compensation on the media data to be processed based on the audio metadata to obtain first media data.

The first loudness compensation includes loudness compensation for dynamic range control.

Specifically, step S302 includes:

Step S3021: Obtain a target performance requirement.

Refer to the descriptions of step S2031 of the embodiment shown in FIG. 2 above for an obtaining way for the target performance requirement. Details are not described herein again.

After the target performance requirement is determined, the target loudness compensation value determining way for dynamic range control and the loudness compensation value determining way for peak limiting are also determined correspondingly.

Step S3022: Determine a target loudness compensation value determining way for dynamic range control corresponding to the target performance requirement based on a correspondence between a performance requirement and a loudness compensation value determining way for dynamic range control.

Corresponding to the second loudness compensation value determining way mentioned above, the loudness compensation value determining way for dynamic range control is also obtained based on a correspondence, and different performance requirements correspond to different determining ways.

In some optional implementations, a loudness equalization effect in the performance requirement is positively correlated with processing complexity of the loudness compensation value determining way for dynamic range control, and loudness equalization processing performance in the performance requirement is negatively correlated with the processing complexity of the loudness compensation value determining way for dynamic range control.

For example, for a playback terminal having a high computing power, a loudness equalization effect is focused on, and thus the loudness compensation value determining way for dynamic range control that has high processing complexity is used; and for a playback terminal having a low computing power, it is impossible to run a determining way having high processing complexity due to limitation of the computing power. Therefore, a determining way with a lower processing complexity is used by satisfying a requirement for high processing performance.

The loudness equalization effect is positively correlated with the processing complexity, and loudness equalization processing performance is negatively correlated with the processing complexity. A correlation is defined to adapt to requirements of playback devices having different computing powers and different loudness equalization effects.

Step S3023: Determine a first loudness compensation value for dynamic range control based on the target loudness compensation value determining way and the audio metadata.

The target loudness compensation value determining way may include a network model having high processing complexity, and may alternatively use a computing method having low processing complexity, and the like. After the target loudness compensation value determining way is obtained, in combination with the audio metadata, the first loudness compensation value for dynamic range control is obtained. If the network model is used, the audio metadata is input into the network model to obtain the first loudness compensation value; or if the computing method is used, the audio metadata is used to perform a corresponding computation to obtain the first loudness compensation value.

In some optional implementations, the performance requirement includes a loudness equalization effect of a first level and a loudness equalization effect of a second level, the first level is lower than the second level. To be specific, the loudness equalization effect of the first level is lower than the loudness equalization effect of the second level, and correspondingly, processing complexity of a determining way corresponding to the loudness equalization effect of the first level is lower than that of a determining way corresponding to the loudness equalization effect of the second level. If the target performance requirement includes the loudness equalization effect of the first level, step S3023 includes:

Step c1: Obtain a slope in dynamic range control parameters and a starting point of a dynamic range in the audio metadata if a length of the media data to be processed is greater than a preset length.

Step c2: Perform loudness estimation based on a target loudness, the slope, and the starting point to determine an estimated loudness.

Step c3: Determine the first loudness compensation value based on a difference between the target loudness and the estimated loudness.

Step c4: Obtain a maximum short-term loudness in the audio metadata if the length of the media data to be processed is less than or equal to the preset length.

Step c5: Determine the first loudness compensation value based on a difference between the maximum short-term loudness and the target loudness.

When the length of the media data to be processed is greater than the preset length, a slope of the dynamic range control curve is obtained, and the starting point of the dynamic range is obtained from the audio feature. Loudness estimation is performed based on the target loudness, the slope, and the starting point, that is, the estimated loudness=(the target loudness−the starting point of the dynamic range)/the slope+the starting point of the dynamic range. After the estimated loudness is obtained, a difference between the target loudness and the estimated loudness is calculated to obtain the first loudness compensation value. For example, the first loudness compensation value=the target loudness−the estimated loudness+1.

When the length of the media data to be processed is less than the preset length, the difference between the maximum short-term loudness and the target loudness is calculated. The difference may be directly determined as the first loudness compensation value, or the difference may be combined with other parameters to obtain the first loudness compensation value.

For example, when the length of the media data to be processed is less than the preset length, if the difference between the maximum short-term loudness and the target loudness is greater than the preset value, the first loudness compensation value=the maximum short-term loudness−the target loudness−the preset value; otherwise, the first loudness compensation value is set to zero. The preset value is set based on actual requirements, for example, the preset value is 5. Certainly, another value may alternatively be used, and set based on actual requirements.

When a length of media data to be played is greater than a preset length, due to the previous dynamic range processing, loudness estimation is performed herein based on the starting point of the dynamic range and the slope, which can ensure accuracy of the obtained loudness estimation. When the length of the media data to be played is less than the preset length, processing of the first loudness compensation value is simplified, and the difference between the maximum short-term loudness and the target loudness is directly used to determine the first loudness compensation value, thereby improving processing efficiency.

In some optional implementations, if the target performance requirement includes the loudness equalization effect of the second level, and a requirement for the loudness equalization effect is high, then a determining way having high processing complexity is used. On this basis, step S3023 includes:

Step d1: Determine the first loudness compensation value based on a first loudness compensation model for dynamic range control and the audio metadata if a length of the media data to be processed is greater than a preset length.

Step d2: Determine the first loudness compensation value based on a second loudness compensation model for dynamic range control and the audio metadata if the length of the media data to be processed is less than or equal to the preset length.

The first loudness compensation model and the second loudness compensation model may be the same or different. For example, when the length of the media data to be processed is greater than the preset length, a model having a moderate processing complexity may be used to satisfy both the processing performance and the loudness equalization effect, because a longer length corresponds to a larger data processing amount. When the length is less than or equal to the preset length, a model having high processing complexity may be used because of a small data processing amount. Therefore, processing complexity of the first loudness compensation model is less than that of the second loudness compensation model.

The first loudness compensation model and the second loudness compensation model may be implemented by using a decision tree model or another neural network model. There is no limitation on their specific network structures herein.

Because the obtained first loudness compensation value is used to compensate for a loudness for dynamic range control, inputs of the first loudness compensation model and the second loudness compensation model may further include control parameters for dynamic range control in addition to the audio metadata.

When there is a high requirement for a loudness equalization effect, a loudness compensation model for dynamic range control is used to determine a loudness compensation value, thereby improving accuracy of the loudness compensation value, and further improving a loudness error control effect.

Step S3024: Perform first loudness compensation on the media data to be processed based on the first loudness compensation value to obtain the first media data.

After the first loudness compensation value is obtained, dynamic range control may be performed on the media data to be processed, and then the first loudness compensation may be performed based on the first loudness compensation value; alternatively, the first loudness compensation value may be used to perform first loudness compensation, and then dynamic range control is performed. The first media data is obtained after dynamic range processing and first loudness compensation.

Step S303: Determine a second loudness compensation value corresponding to peak limiting based on an audio feature of the first media data. Refer to step S203 of the embodiment shown in FIG. 2 for details. Details are not described herein again.

Step S304: Perform second loudness compensation and peak limiting on the first media data based on the second loudness compensation value to determine target media data for playback. Refer to step S104 of the embodiment shown in FIG. 1 for details. Details are not described herein again.

In the audio processing method provided in this embodiment, during the loudness compensation for dynamic range control, the correspondence between the performance requirement and the loudness compensation value determining way for dynamic range control is used to obtain the target loudness compensation value determining way applicable to the target performance requirement, so as to balance the computing power of the playback device and the loudness equalization effect.

In some optional implementations, the obtaining audio metadata of the media data to be processed in the above embodiments includes: obtaining a frequency response curve of a target playback device, where the frequency response curve is used to determine a target loudness. Because the frequency response curve is corresponding to the target playback device, the obtained target loudness is also applicable to the target playback device.

In some optional implementations, the obtaining audio metadata of the media data to be processed in the above embodiments includes: obtaining a cutoff frequency of the target playback device, where the cutoff frequency is used to determine a filtered loudness compensation value corresponding to signal energy of data to be filtered in the media data to be processed, the data to be filtered is media data with a frequency lower than the cutoff frequency in the media data to be processed, the target playback device is configured to perform loudness processing on the media data to be processed based on the filtered loudness compensation value after filtering the data to be filtered from the media data to be processed, and the audio metadata includes the target loudness and the filtered loudness compensation value.

In a loudspeaker playback mode, a playback terminal is limited by a cutoff frequency of a loudspeaker, and consequently, the playback terminal has high attenuation of a low-frequency signal when using the loudspeaker to play media data. The low-frequency signal is a signal with a frequency lower than the cutoff frequency, and a preset frequency may be 100 Hz, 150 Hz, or 200 Hz, depending on the performance of the playback terminal. The low-frequency signal may be attenuated by 20 dB to 40 dB, or even a wider range of dB values. For a large quantity of short video playback scenarios such as voice, music, and movies, a low-frequency signal is a part that cannot be ignored. For example, the lack of playback energy of a signal such as a human voice, a drumbeat, or a musical instrument inevitably leads to the problems of uneven video playback loudness, fluctuating volume, and the like even after performing loudness equalization in a digital domain during loudspeaker playback, resulting in more frequent volume adjustment in the loudspeaker mode. Because audio data below the cutoff frequency cannot be played back normally in the loudspeaker mode, this part of data is referred to as data to be filtered. After filtering this part of data to be filtered, the playback terminal uses the filtered loudness compensation value to compensate for energy of this part of data, and uses a loudness gain to perform loudness equalization on this part of data.

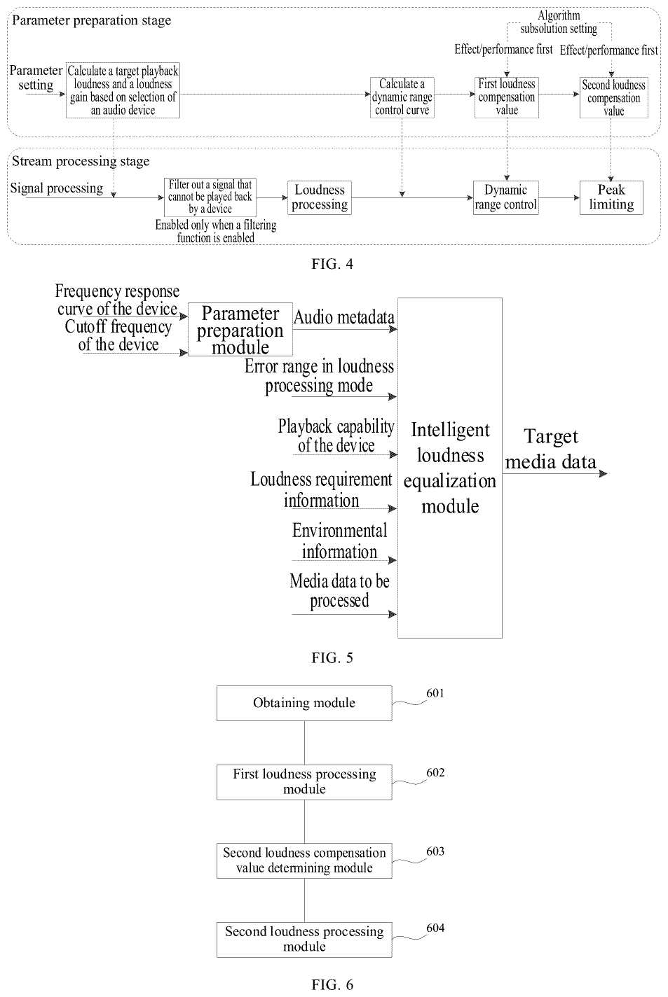

For example, as shown in FIG. 4, an entire audio processing procedure may be divided into a parameter preparation stage and a stream processing stage. The parameter preparation stage may be completed on a server side or at the playback terminal. There is no limitation on it herein. The parameter preparation stage includes calculating a target playback loudness and a loudness gain based on selection of an audio device, where the loudness gain is calculated by using a difference between a source loudness and a target loudness. The determination of the target loudness is related to loudness requirement information, environmental information, a playback capability of a device, and a frequency response curve of the device. The loudness requirement information includes but is not limited to a requirement of a user for a playback loudness, and the environmental information includes whether a current environment is a quiet scenario or a noisy scenario, and the like. In the parameter preparation stage, it is necessary to further calculate the dynamic range control curve, the first loudness compensation value, and the second loudness compensation value. The first loudness compensation value is used for loudness compensation for dynamic range control, and the second loudness compensation value is used for loudness compensation for peak limiting. The stream processing stage means using an intelligent loudness equalization module to perform loudness equalization processing on the media data to be processed, including but not limited to filtering out, by using the cutoff frequency of the device when a filtering function is enabled, a signal that cannot be played back by the device, then performing loudness compensation on a filtered-out signal by using the filtered loudness compensation value, and performing dynamic range control and peak limiting to obtain the target media data for playback.

Correspondingly, FIG. 5 shows functional modules involved in the audio processing procedure, including a parameter preparation module and an intelligent loudness equalization module. The parameter preparation module is configured to determine the audio metadata, and the intelligent loudness equalization module is configured to perform loudness equalization processing on the media data to be processed to obtain the target media data. FIG. 4 and FIG. 5 describe the audio processing procedure from the perspectives of data flow and functional modules, respectively.

The target loudness and the filtered loudness compensation value can be accurately determined by providing an interface for obtaining a frequency response curve or a cutoff frequency, so as to achieve an effect of loudness equalization processing for a specific device.

As a specific application embodiment of the embodiments of the present disclosure, the audio processing method is applied to a short video playback scenario. In the short video playback scenario, a user posts a video to a cloud. When the video is posted, or a parameter preparation module of a cloud server processes the video to obtain audio metadata corresponding to each piece of media data to be processed, and sends the audio metadata to a playback terminal during playback. The playback terminal is provided with a loudness processing mode or error range setting interface, and a target performance requirement is determined through interaction with the setting interface; alternatively, the playback terminal determines the target performance requirement by querying its own device performance. The playback capability of the device may be obtained by performing capability prediction through volume event tracking, the loudness requirement information is selected by different service scenario delivery policies or selected interactively by the user, and the environmental information is obtained by collecting a current ambient volume, and so on. The data is input into the intelligent loudness equalization module for processing to obtain the target media data. Specifically, for the media data to be processed, when the playback terminal is in the loudspeaker playback mode, the media data to be processed is filtered based on the cutoff frequency of the playback terminal to filter out a signal that cannot be played back. The filtered loudness compensation value is then calculated based on filtered-out signal energy to perform loudness compensation on the filtered signal. The calculated dynamic range control curve is used to perform dynamic range control on the filtered signal, and the first loudness compensation value is used to perform first loudness compensation on the signal obtained after dynamic range control. The second loudness compensation value is then used to perform second loudness compensation on the signal obtained after peak limiting, so as to obtain the target media data for playback.

As another specific application embodiment of the embodiments of the present disclosure, the audio processing method is applied to a user playback scenario of a music playback platform, and a specific processing procedure thereof is similar to the processing procedure applied to the short video playback scenario as described above. Details are not described herein again.

As still another specific application embodiment of the embodiments of the present disclosure, the audio processing method is applied to a local audio playback scenario. A frequency response curve and a cutoff frequency of a playback device are read from a local configuration file, and audio metadata is obtained through scanning after local audio is archived. A loudness processing mode or error range is determined interactively, so as to determine the target performance requirement. The playback capability of the device is read from a local configuration file, the loudness requirement information is selected by different service scenario delivery policies or selected interactively by the user, and the environmental information is obtained by collecting a current ambient volume, and so on. The data is input into the intelligent loudness equalization module for processing to obtain the target media data.

Settings of input parameters are standardized and improved in an entire method chain of audio processing described above, which mainly achieves an intelligent loudness equalization sound effect chain adapted to the device, and different subsolutions can be selected based on the input parameters. To be specific, by determining the target performance requirement, the first loudness compensation value and the second loudness compensation value are obtained by using different determining ways, thereby achieving a balance between saving calculated performance and achieving a more equalized loudness effect and providing choices to satisfy different requirements.

This embodiment further provides an audio processing apparatus. The apparatus is configured to implement the above embodiments and preferred implementations, which have already been described and details are not described herein again. As used hereinafter, the term “module” may be a combination of software and/or hardware that implements a predetermined function. Although the apparatus described in the following embodiment is preferably implemented in software, an implementation in hardware, or a combination of software and hardware, is also possible and contemplated.

This embodiment provides an audio processing apparatus. As shown in FIG. 6, the apparatus includes:

an obtaining module 601 configured to obtain media data to be processed and audio metadata of the media data to be processed;

a first loudness processing module 602 configured to perform first loudness compensation on the media data to be processed based on the audio metadata to obtain first media data, where the first loudness compensation includes loudness compensation for dynamic range control;

a second loudness compensation value determining module 603 configured to determine a second loudness compensation value corresponding to peak limiting based on an audio feature of the first media data; and
a second loudness processing module 604 configured to perform second loudness compensation and peak limiting on the first media data based on the second loudness compensation value to determine target media data for playback.

In some optional implementations, the second loudness compensation value determining module 603 includes:
a first performance requirement obtaining unit configured to obtain a target performance requirement;
a second loudness compensation determining unit configured to determine a second loudness compensation value determining way corresponding to the target performance requirement based on a correspondence between a performance requirement and a loudness compensation value determining way corresponding to peak limiting; and
a second loudness compensation value determining unit configured to determine the second loudness compensation value based on the second loudness compensation value determining way and the audio feature of the first media data.

In some optional implementations, a loudness equalization effect in the performance requirement is positively correlated with processing complexity of the loudness compensation value determining way for peak limiting, and loudness equalization processing performance in the performance requirement is negatively correlated with the processing complexity of the loudness compensation value determining way for peak limiting.

In some optional implementations, the peak loudness compensation value determining way includes a determining way based on a mapping relationship between a peak loudness compensation value and an audio feature, and a determining way based on a peak loudness compensation model, and the peak loudness compensation model includes the audio feature as an input and includes the loudness compensation value as an output. Processing complexity of the determining way based on the mapping relationship between the peak loudness compensation value and the audio feature is less than that of the determining way based on the peak loudness compensation model.

In some optional implementations, if the peak loudness compensation value determining way is the determining way based on the mapping relationship between the peak loudness compensation value and the audio feature, the second loudness compensation value determining unit includes:
a peak obtaining subunit configured to obtain a target peak for the peak limiting and a current audio peak in the audio feature to obtain a difference between the current audio peak and the target peak; and
a mapping relationship determining subunit for the second loudness compensation value configured to determine the second loudness compensation value based on the difference and the mapping relationship.

In some optional implementations, if the peak loudness compensation value determining way is the determining way based on the peak loudness compensation model, the second loudness compensation value determining unit includes:
a target submodel determining subunit configured to determine a target submodel in the peak loudness compensation model based on a loudness equalization effect in the target performance requirement, where the peak loudness compensation model includes a plurality of submodels, and the submodels have different processing complexity; and
a model determining subunit for the second loudness compensation value configured to determine the second loudness compensation value based on the target submodel and the audio feature of the first media data.

In some optional implementations, the first loudness processing module 602 includes:
a second performance requirement obtaining unit configured to obtain a target performance requirement;
a target loudness compensation determining unit configured to determine a target loudness compensation value determining way for dynamic range control corresponding to the target performance requirement based on a correspondence between a performance requirement and a loudness compensation value determining way for dynamic range control;
a first loudness compensation value determining unit configured to determine a first loudness compensation value for dynamic range control based on the target loudness compensation value determining way and the audio metadata; and
a first loudness compensation unit configured to perform first loudness compensation on the media data to be processed based on the first loudness compensation value to obtain the first media data.

In some optional implementations, a loudness equalization effect in the performance requirement is positively correlated with processing complexity of the loudness compensation value determining way for dynamic range control, and loudness equalization processing performance in the performance requirement is negatively correlated with the processing complexity of the loudness compensation value determining way for dynamic range control.

In some optional implementations, the performance requirement includes a loudness equalization effect of a first level and a loudness equalization effect of a second level, the first level is lower than the second level, and if the target performance requirement includes the loudness equalization effect of the first level, the first loudness compensation value determining unit includes:
a data obtaining subunit configured to obtain a slope in dynamic range control parameters and a starting point of a dynamic range in the audio metadata if a length of the media data to be processed is greater than a preset length;
a loudness estimation subunit configured to perform loudness estimation based on a target loudness, the slope, and the starting point to determine an estimated loudness; and
a first loudness compensation value estimation determining subunit configured to determine the first loudness compensation value based on a difference between the target loudness and the estimated loudness.

In some optional implementations, the first loudness compensation value determining unit further includes:
a maximum short-term loudness obtaining subunit configured to obtain a maximum short-term loudness in the audio metadata if the length of the media data to be processed is less than or equal to the preset length; and
a first loudness compensation value difference determining subunit configured to determine the first loudness compensation value based on a difference between the maximum short-term loudness and the target loudness.

In some optional implementations, the performance requirement includes a loudness equalization effect of a first level and a loudness equalization effect of a second level, the first level is lower than the second level, and if the target performance requirement includes the loudness equalization effect of the second level, the first loudness compensation value determining unit includes:
a first loudness compensation model determining subunit configured to determine the first loudness compensation value based on a first loudness compensation model for dynamic range control and the audio metadata if a length of the media data to be processed is greater than a preset length.

In some optional implementations, the first loudness compensation value determining unit further includes:
a second loudness compensation model determining subunit configured to determine the first loudness compensation value based on a second loudness compensation model for dynamic range control and the audio metadata if the length of the media data to be processed is less than or equal to the preset length.

In some optional implementations, the target performance requirement is determined based on a loudness processing mode of a current playback device or an error range of loudness compensation.

In some optional implementations, the obtaining module 601 includes:
a spectrum curve obtaining unit configured to obtain a frequency response curve of a target playback device, where the frequency response curve is used to determine a target loudness; and/or a cutoff frequency obtaining unit configured to obtain a cutoff frequency of the target playback device, where the cutoff frequency is used to determine a filtered loudness compensation value corresponding to signal energy of data to be filtered in the media data to be processed, the data to be filtered is media data with a frequency lower than the cutoff frequency in the media data to be processed, the target playback device is configured to perform loudness processing on the media data to be processed based on the filtered loudness compensation value after filtering the data to be filtered from the media data to be processed, and the audio metadata includes the target loudness and the filtered loudness compensation value.

The audio processing apparatus in this embodiment is presented in the form of a functional unit, the unit herein is an application specific integrated circuit (ASIC), a processor and a memory that execute one or more software programs or fixed programs, and/or another device that can provide the above functions.

Further functional descriptions of the above modules and units are the same as those in the above corresponding embodiments. Details are not described herein again.

An embodiment of the present disclosure further provides an electronic device having the audio processing apparatus shown in FIG. 6.

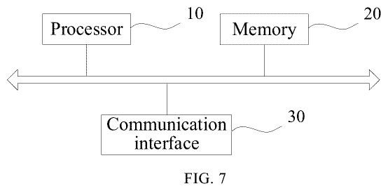

FIG. 7 is a schematic diagram of a structure of an electronic device according to an optional embodiment of the present disclosure. As shown in FIG. 7, the electronic device includes: one or more processors 10, a memory 20, and interfaces for connecting components, including a high-speed interface and a low-speed interface. The components are communicatively connected to each other by using different buses, and may be mounted on a common motherboard or otherwise mounted as desired. The processor may process instructions to be executed within the electronic device, including instructions stored in or on the memory to display graphical information of a GUI on an external input/output apparatus (for example, a display device coupled to an interface). In some optional implementations, a plurality of processors and/or a plurality of buses may be used with a plurality of memories, if desired. Similarly, a plurality of electronic devices may be connected, and each device provides some of the necessary operations (for example, used as a server array, a set of blade servers, or a multi-processor system). One processor 10 is used as an example in FIG. 7.

The processor 10 may be a central processing unit, a network processor, or a combination thereof. The processor 10 may further include a hardware chip. The hardware chip may be an application specific integrated circuit, a programmable logic device, or a combination thereof. The programmable logic device may be a complex programmable logic device, a field-programmable logic gate array, a general-purpose array logic, or any combination thereof.

The memory 20 stores instructions that can be executed by at least one processor 10 to cause the at least one processor 10 to perform the method shown in the above embodiment.

The memory 20 may include a program storage area and a data storage area. The program storage area may store an operating system, and an application required by at least one function; and the data storage area may store data created based on use of the electronic device, and the like. In addition, the memory 20 may include a high-speed random access memory, and may further include a non-transitory memory, such as at least one magnetic disk storage device, a flash memory device, or another non-transitory solid-state storage device. In some optional implementations, the memory 20 may optionally include memories that are remotely disposed relative to the processor 10, and these remote memories may be connected to the electronic device over a network. Examples of the network include, but are not limited to, the Internet, an intranet, a local area network, a mobile communication network, and a combination thereof.

The memory 20 may include a volatile memory, such as a random access memory; the memory may further include a non-volatile memory, such as a flash memory, a hard disk, or a solid state disk; the memory 20 may further include a combination of the above types of memories.

The electronic device further includes a communication interface 30 for the electronic device to communicate with another device or communication network.

An embodiment of the present disclosure further provides a computer-readable storage medium. The above method according to an embodiment of the present disclosure may be implemented in hardware or firmware, or implemented as computer code that may be recorded on a storage medium, or implemented as computer code that is originally stored on a remote storage medium or a non-transitory machine-readable storage medium downloaded over a network and that is to be stored on a local storage medium, so that the method described herein may be processed by such software stored on a storage medium using a general-purpose computer, a special-purpose processor, or programmable or special-purpose hardware. The storage medium may be a magnetic disk, an optical disc, a read-only memory, a random access memory, a flash memory, a hard disk, a solid state disk, or the like. Further, the storage medium may further include a combination of the above types of memories. It can be understood that a computer, a processor, a microprocessor controller, or programmable hardware includes a storage component that can store or receive software or computer code, and when the software or the computer code is accessed and executed by the computer, the processor, or the hardware, the method shown in the above embodiment is implemented.

Although the embodiments of the present disclosure are described with reference to the accompanying drawings, those skilled in the art would provide various modifications and variations without departing from the spirit and scope of the present disclosure, and such modifications and variations shall all fall within the scope defined by the appended claims.

I/We claim:

1. An audio processing method, wherein the method comprises:
obtaining media data to be processed and audio metadata of the media data to be processed;
performing first loudness compensation on the media data to be processed based on the audio metadata to obtain first media data, wherein the first loudness compensation comprises loudness compensation for dynamic range control;
determining a second loudness compensation value corresponding to peak limiting based on an audio feature of the first media data; and
performing second loudness compensation and peak limiting on the first media data based on the second loudness compensation value to determine target media data for playback.

2. The method according to claim 1, wherein determining the second loudness compensation value corresponding to peak limiting based on the audio feature of the first media data comprises:
obtaining a target performance requirement;
determining a second loudness compensation value determining way corresponding to the target performance requirement based on a correspondence between a performance requirement and a loudness compensation value determining way corresponding to peak limiting; and
determining the second loudness compensation value based on the second loudness compensation value determining way and the audio feature of the first media data.

3. The method according to claim 2, wherein a loudness equalization effect in the performance requirement is positively correlated with processing complexity of the loudness compensation value determining way for peak limiting, and loudness equalization processing performance in the performance requirement is negatively correlated with the processing complexity of the loudness compensation value determining way for peak limiting.

4. The method according to claim 3, wherein the peak loudness compensation value determining way comprises a determining way based on a mapping relationship between a peak loudness compensation value and an audio feature, and a determining way based on a peak loudness compensation model, wherein the peak loudness compensation model comprises the audio feature as an input and comprises the loudness compensation value as an output, wherein processing complexity of the determining way based on the mapping relationship between the peak loudness compensation value and the audio feature is less than that of the determining way based on the peak loudness compensation model.

5. The method according to claim 4, wherein in response to the peak loudness compensation value determining way being the determining way based on the mapping relationship between the peak loudness compensation value and the audio feature, determining the second loudness compensation value based on the second loudness compensation value determining way and the audio feature of the first media data comprises:
obtaining a target peak for the peak limiting and a current audio peak in the audio feature to obtain a difference between the current audio peak and the target peak; and
determining the second loudness compensation value based on the difference and the mapping relationship.

6. The method according to claim 4, wherein in response to the peak loudness compensation value determining way being the determining way based on the peak loudness compensation model, determining the second loudness compensation value based on the second loudness compensation value determining way and the audio feature of the first media data comprises:
determining a target submodel in the peak loudness compensation model based on a loudness equalization effect in the target performance requirement, wherein the peak loudness compensation model comprises a plurality of submodels, and the submodels have different processing complexity; and
determining the second loudness compensation value based on the target submodel and the audio feature of the first media data.

7. The method according to claim 1, wherein performing first loudness compensation on the media data to be processed based on the audio metadata to obtain first media data comprises:
obtaining a target performance requirement;
determining a target loudness compensation value determining way for dynamic range control corresponding to the target performance requirement based on a correspondence between a performance requirement and a loudness compensation value determining way for dynamic range control;
determining a first loudness compensation value for dynamic range control based on the target loudness compensation value determining way and the audio metadata; and
performing first loudness compensation on the media data to be processed based on the first loudness compensation value to obtain the first media data.

8. The method according to claim 7, wherein a loudness equalization effect in the performance requirement is positively correlated with processing complexity of the loudness compensation value determining way for dynamic range control, and loudness equalization processing performance in the performance requirement is negatively correlated with the processing complexity of the loudness compensation value determining way for dynamic range control.

9. The method according to claim 8, wherein the performance requirement comprises a loudness equalization effect of a first level and a loudness equalization effect of a second level, the first level is lower than the second level, and in response to the target performance requirement comprising the loudness equalization effect of the first level, determining the first loudness compensation value for dynamic range control based on the target loudness compensation value determining way and the audio metadata comprises:
obtaining a slope in dynamic range control parameters and a starting point of a dynamic range in the audio metadata in response to a length of the media data to be processed being greater than a preset length;
performing loudness estimation based on a target loudness, the slope, and the starting point to determine an estimated loudness; and
determining the first loudness compensation value based on a difference between the target loudness and the estimated loudness.

10. The method according to claim 9, wherein determining the first loudness compensation value for dynamic range control based on the target loudness compensation value determining way and the audio metadata further comprises:
obtaining a maximum short-term loudness in the audio metadata in response to the length of the media data to be processed being less than or equal to the preset length; and
determining the first loudness compensation value based on a difference between the maximum short-term loudness and the target loudness.

11. The method according to claim 8, wherein the performance requirement comprises a loudness equalization effect of a first level and a loudness equalization effect of a second level, the first level is lower than the second level, and in response to the target performance requirement comprising the loudness equalization effect of the second level, determining the first loudness compensation value for dynamic range control based on the target loudness compensation value determining way and the audio metadata comprises:
determining the first loudness compensation value based on a first loudness compensation model for dynamic range control and the audio metadata in response to a length of the media data to be processed being greater than a preset length.

12. The method according to claim 11, wherein determining the first loudness compensation value for dynamic range control based on the target loudness compensation value determining way and the audio metadata further comprises:
determining the first loudness compensation value based on a second loudness compensation model for dynamic range control and the audio metadata in response to the length of the media data to be processed being less than or equal to the preset length.

13. The method according to claim 2, wherein the target performance requirement is determined based on a loudness processing mode of a current playback device or an error range of loudness compensation.

14. The method according to claim 1, wherein obtaining the audio metadata of the media data to be processed comprises:
obtaining a frequency response curve of a target playback device, wherein the frequency response curve is used to determine a target loudness;
and/or
obtaining a cutoff frequency of the target playback device, wherein the cutoff frequency is used to determine a filtered loudness compensation value corresponding to signal energy of data to be filtered in the media data to be processed, the data to be filtered is media data with a frequency lower than the cutoff frequency in the media data to be processed, the target playback device is configured to perform loudness processing on the media data to be processed based on the filtered loudness compensation value after filtering the data to be filtered from the media data to be processed, and the audio metadata comprises the target loudness and the filtered loudness compensation value.

15. An electronic device, comprising:
a memory and a processor, wherein the memory and the processor are communicatively connected to each other, the memory stores computer instructions, and the computer instructions, when executed by the processor, cause the processor to:
obtain media data to be processed and audio metadata of the media data to be processed;
perform first loudness compensation on the media data to be processed based on the audio metadata to obtain first media data, wherein the first loudness compensation comprises loudness compensation for dynamic range control;
determine a second loudness compensation value corresponding to peak limiting based on an audio feature of the first media data; and
perform second loudness compensation and peak limiting on the first media data based on the second loudness compensation value to determine target media data for playback.

16. The electronic device of claim 15, wherein the computer instructions for determining the second loudness compensation value corresponding to peak limiting based on the audio feature of the first media data further cause the processor to:
obtain a target performance requirement;
determine a second loudness compensation value determining way corresponding to the target performance requirement based on a correspondence between a performance requirement and a loudness compensation value determining way corresponding to peak limiting; and
determine the second loudness compensation value based on the second loudness compensation value determining way and the audio feature of the first media data.

17. The electronic device of claim 16, wherein a loudness equalization effect in the performance requirement is positively correlated with processing complexity of the loudness compensation value determining way for peak limiting, and loudness equalization processing performance in the performance requirement is negatively correlated with the processing complexity of the loudness compensation value determining way for peak limiting.

18. The electronic device of claim 17, wherein the second loudness compensation value determining way comprises a determining way based on a mapping relationship between a peak loudness compensation value and an audio feature, and a determining way based on a peak loudness compensation model, wherein the peak loudness compensation model comprises the audio feature as an input and comprises the loudness compensation value as an output, wherein processing complexity of the determining way based on the mapping relationship between the peak loudness compensation value and the audio feature is less than that of the determining way based on the peak loudness compensation model.

19. The electronic device of claim 18, wherein in response to the peak loudness compensation value determining way being the determining way based on the mapping relationship between the peak loudness compensation value and the audio feature, the computer instructions for determining the second loudness compensation value based on the second loudness compensation value determining way and the audio feature of the first media data further cause the processor to:
obtain a target peak for the peak limiting and a current audio peak in the audio feature to obtain a difference between the current audio peak and the target peak; and
determine the second loudness compensation value based on the difference and the mapping relationship.

20. A non-transitory computer-readable storage medium, having stored thereon computer instructions that are used to cause a computer to:
obtain media data to be processed and audio metadata of the media data to be processed;
perform first loudness compensation on the media data to be processed based on the audio metadata to obtain first media data, wherein the first loudness compensation comprises loudness compensation for dynamic range control;
determine a second loudness compensation value corresponding to peak limiting based on an audio feature of the first media data; and
perform second loudness compensation and peak limiting on the first media data based on the second loudness compensation value to determine target media data for playback.
